(19) United States
(12) Patent Application Publication
(10) Pub. No.: US 2026/0170875 A1
(43) Pub. Date: Jun. 18, 2026

(54) SYSTEM AND METHOD FOR VISUAL DETECTION OF GESTURES IN AN EXTENDED REALITY ENVIRONMENT

(71) Applicant: GOOGLE LLC, Mountain View, CA (US)

(72) Inventors: Jacob Pawek, Cupertino, CA (US); Stiven Guillaume Francois Morvan, New York City, NY (US); Zhaowei Wang, Stittsville (CA); Fan Yuan Ng, Mountain View, CA (US); Dongeek Shin, San Jose, CA (US)

(21) Appl. No.: 19/425,441

(22) Filed: Dec. 18, 2025

Related U.S. Application Data
(60) Provisional application No. 63/735,742, filed on Dec. 18, 2024.

(51) Int. Cl. G06V 40/20; G06F 3/01

(52) U.S. Cl. CPC G06V 40/28; G06F 3/017

(57) ABSTRACT

Systems and methods for processing user hand gestures are disclosed. A method can receive perception data for a hand, the perception data comprising a plurality of keypoints and a pinch score. A hand dominance state is determined for the hand, designating it as either a dominant or non-dominant hand. A multi-stage filtering pipeline then processes the perception data to generate a final, filtered pinch score. The filters within the pipeline are selectively applied and their criteria dynamically adjusted based on the hand dominance state. For example, a velocity filter may be applied to a new pinch gesture from the non-dominant hand to validate user intent but not applied to the dominant hand. A user interface interaction event is then initiated based on the filtered pinch score. This approach reduces false-positive gesture detections arising from unintentional hand poses, enhancing the reliability of gesture-based control in virtual or augmented reality environments.

### CROSS-REFERENCE TO RELATED APPLICATION

This application claims the benefit of U.S. Provisional Application No. 63/735,742, filed on Dec. 18, 2024, which is hereby incorporated by reference in its entirety.

### BACKGROUND

Interaction with extended reality (XR) environments, such as those presented by virtual reality (VR) or augmented reality (AR) devices, may be facilitated through hand gestures. Hand gestures can provide an intuitive and direct method for manipulating virtual objects compared to traditional input devices. Accordingly, the accurate detection of such pinch gestures is a key factor for enabling reliable and precise control within the XR environment.

### SUMMARY

Disclosed herein are systems and methods for processing user hand gestures in a computing environment to improve the accuracy of interaction events. The technical solutions address the technical problems of false-positive gesture detections, which can arise from unintentional user hand movements or from degradation in perception data quality.

In some aspects, the techniques described herein relate to a method including: determining a dominant hand of a user based on previous pinch gestures; acquiring video data of a hand of the user; applying the video data to a pinch model to generate a pinch score and keypoints for the hand of the user; and applying the pinch score and the keypoints to a multistage filtering pipeline to generate a final pinch score, the multistage filtering pipeline including: a confidence filter configured to determine a confidence corresponding to the keypoints and pass the pinch score for further processing when the confidence satisfies a criterion, the criterion being stricter for a non-dominant hand and when a new pinch is detected; and a velocity filter configured to determine a closing velocity corresponding to the keypoints and force the pinch score to a low value when the closing velocity is below a velocity threshold, wherein the velocity filter is only applied to the non-dominant hand and is enabled only when the new pinch is detected.

In some aspects, the techniques described herein relate to a head-worn device, including: a camera configured to acquire video data of a hand of a user; a processor; and a memory storing instructions, that when executed by the processor, cause the head-worn device to: determine a dominant hand of the user based on previous pinch gestures; apply the video data to a pinch model to generate a pinch score and keypoints for the hand of the user; and apply the pinch score and the keypoints to a multistage filtering pipeline to generate a final pinch score, the multistage filtering pipeline including: a confidence filter configured to determine a confidence corresponding to the keypoints and pass the pinch score for further processing when the confidence satisfies a criterion, the criterion being stricter for a non-dominant hand and when a new pinch is detected; and a velocity filter configured to determine a closing velocity corresponding to the keypoints and force the pinch score to a low value when the closing velocity is below a velocity threshold, wherein the velocity filter is only applied to the non-dominant hand and is enabled only when the new pinch is detected.

In some aspects, the techniques described herein relate to a non-transitory computer-readable medium storing instructions that, when executed by a processor, cause the processor to: determine a dominant hand of a user based on previous pinch gestures; acquire video data of a hand of the user; apply the video data to a pinch model to generate a pinch score and keypoints for the hand of the user; and apply the pinch score and the keypoints to a multistage filtering pipeline to generate a final pinch score, the multistage filtering pipeline including: a confidence filter configured to determine a confidence corresponding to the keypoints and pass the pinch score for further processing when the confidence satisfies a criterion, the criterion being stricter for a non-dominant hand and when a new pinch is detected; and a velocity filter configured to determine a closing velocity corresponding to the keypoints and force the pinch score to a low value when the closing velocity is below a velocity threshold, wherein the velocity filter is only applied to the non-dominant hand and is enabled only when the new pinch is detected.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is an illustration of a user interacting with a head-worn device with a pinch gesture according to a possible implementation of the present disclosure.

FIG. 2 illustrates keypoint data generated by a model for determining a pinch gesture according to a possible implementation of the present disclosure.

FIG. 3 is a system block diagram of a pinch detection system according to a possible implementation of the present disclosure.

FIG. 4 is a multistage filtering pipeline for computing a final pinch score according to possible implementation of the present disclosure.

FIG. 5 illustrates a strength filter for the multistage filtering pipeline of FIG. 4 according to a possible implementation of the present disclosure.

FIG. 6 illustrates a confidence filter for the multistage filtering pipeline of FIG. 4 according to a possible implementation of the present disclosure.

FIG. 7 illustrates a velocity filter for the multistage filtering pipeline of FIG. 4 according to a possible implementation of the present disclosure.

FIG. 8 is a method for registering a pinch gesture according to a possible implementation of the present disclosure.

FIG. 9 illustrates a head-worn device according to a possible implementation of the present disclosure.

The components in the drawings are not necessarily to scale relative to each other. Like reference numerals designate corresponding parts throughout the several views.

### DETAILED DESCRIPTION

Head-worn devices (i.e., head-mounted devices), such as virtual reality (VR) or augmented reality (AR) headsets, may utilize vision-based systems to detect user hand gestures for interacting with a three-dimensional (3D) environment. A fundamental hand gesture for such interaction is the pinch gesture.

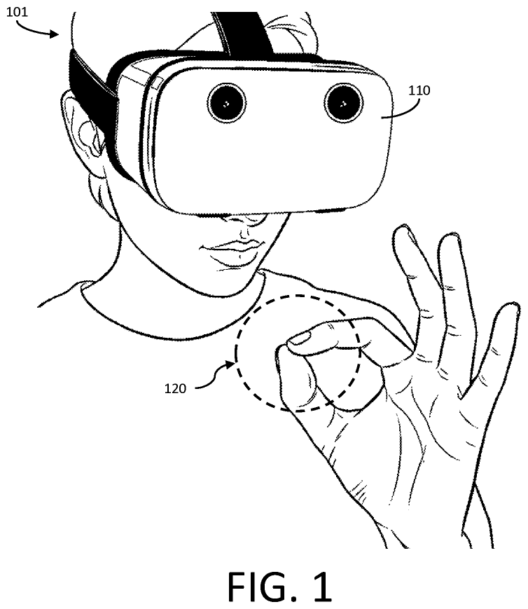

FIG. 1 is an illustration of a user 101 interacting with a head-worn device 110 with a pinch gestured according to a possible implementation of the present disclosure. As shown, the pinch gesture 120 may be formed by a user bringing the tip of their index finger into contact with the tip of their thumb. The pinch gesture can be interpreted in different ways depending on its duration. A brief pinch and release action may be analogous to a single click of a mouse, used for discrete actions such as selecting a user interface element or confirming a dialog box. In contrast, a pinch and hold action, where the user maintains contact between their fingertips, may be used for continuous interactions, such as grasping a virtual object to move it within the 3D environment or resizing a window. For example, a VR application may allow a user to point at a virtual object, perform a pinch and hold gesture to ‘grab’ the object, move the object to a new location by moving their hand, and then release the pinch to ‘drop’ the object at the new location.

As depicted in FIG. 1, the head-worn device 110 is an extended reality headset comprising the hardware and software subsystems necessary to implement the multistage filtering pipeline. The device includes one or more cameras configured to acquire video data of the user's hands as they move and gesture within the device's field of view. Internally, the device contains a processor and a memory. The memory stores instructions that, when executed by the processor, form a pinch gesture recognition system.

A technical problem with pinch gesture recognition systems is that they can register a pinch gesture that was not intended (i.e., false-positive detection). These false positives can result from various factors, including the inherent limitations of vision-based modeling across different users, lighting conditions, and environments, as well as from unintentional hand poses. For example, a user focusing on an interaction with their dominant hand may unconsciously rest their non-dominant hand in a position that the system misinterprets as a pinch gesture. Such unintended inputs can lead to erroneous system behavior, such as activating incorrect user interface elements, switching application focus, or locking a cursor, thereby degrading the reliability of the human-computer interface.

To address this technical problem, the disclosed pinch gesture recognition system introduces a framework of heuristics that functions as a multistage filtering pipeline (i.e., multistage pipeline, pipeline, etc.) to validate raw pinch data from the vision-based detection model. This framework analyzes various attributes of a potential pinch gesture before confirming it as an intentional pinch-gesture and taking a subsequent action (i.e., click, grab). The multistage pipeline includes several distinct filtering stages to apply the heuristics to validate the pinch gesture.

The head-worn device 110, shown in FIG. 1, includes a vision-based pinch model, which processes the video data from the cameras to generate an initial pinch score and a set of hand keypoints. The processor is further configured to execute the multistage filtering pipeline, which receives the pinch score and keypoints from the pinch model. The pipeline applies a series of heuristic filters, such as a confidence filter and a velocity filter, to validate the gesture and reduce false-positive detections, ultimately producing a final pinch score for use in user interactions. The multistage pipeline provides the technical effect of reducing false-positive gesture detections, which results in a more robust and reliable human-computer interface for the head-worn device, thereby improving the overall user experience by ensuring that only intentional user inputs are registered (i.e., detected).

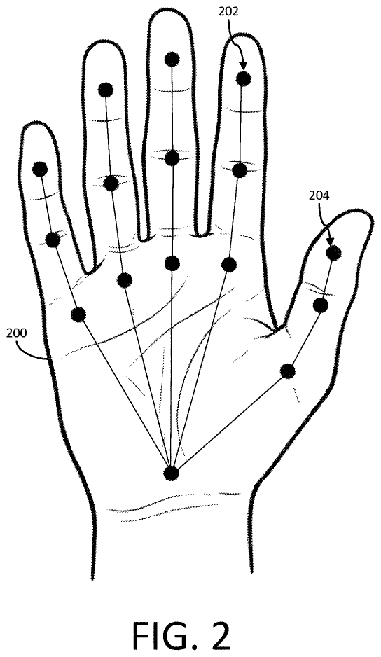

FIG. 2 illustrates keypoint data generated by a vision model (i.e., model) for determining a pinch gesture according to a possible implementation of the present disclosure.

The model may visually recognize features of the hand 200 from a frame (i.e., image) of video data. The features may include the joints of the fingers, the tips of the fingers, and the base of the hand (i.e., at the wrist). The model may be configured to assign keypoints to the recognized features. A pose of the hand may be determined based on the relative locations of the keypoints. For example, a pinch gesture may be based on the spatial relationship between an index fingertip keypoint 202 and a thumb tip keypoint 204. Additionally, a left hand may be distinguished from a right hand based on the spatial relationships between the keypoints and a visual recognition of a front of the hand or a back of the hand.

Each keypoint may include not only a position (e.g., spatial coordinates) but also a confidence score, which quantifies the model's certainty regarding the accuracy of the detected position. For instance, a confidence score may be a normalized value (e.g., from 0 to 1), where a higher value signifies greater certainty. High confidence for a keypoint might be achieved when the hand is well-illuminated, stationary, and fully within the camera's field of view. Conversely, a low confidence score could be attributed to factors like poor lighting conditions, rapid hand movements resulting in motion blur, or partial occlusion where another object or the hand itself obstructs a clear view of the keypoint. This confidence data provides a metric for evaluating the reliability of the overall hand pose detection. The multistage pipeline includes a confidence filter configured to assess the reliability of the keypoint data provided by the model.

Keypoint positions may be tracked over frames to determine a movement. In this context, tracking refers to the process of continuously estimating the three-dimensional position and orientation of the hand's keypoints across sequential video frames, which enables the system to construct a dynamic model of hand motion for subsequent kinematic analysis. This temporal analysis involves comparing the spatial coordinates of a given keypoint, such as the thumb tip keypoint 204, across a sequence of consecutive video frames. By analyzing the displacement of these keypoints over time, the system can compute kinematic data, including the velocity and trajectory of the fingertips. For a pinch gesture, this allows for the calculation of the relative velocity between the index fingertip keypoint 202 and the thumb tip keypoint 204. This kinematic information is particularly valuable for distinguishing between a deliberate pinching motion, which is characterized by a discernible closing velocity, and a static hand pose that may coincidentally resemble a pinch. The multistage pipeline includes a velocity filter, configured to analyze the closing velocity between the thumb and index fingertips to provide another layer of data for validating the user's intent and reducing false-positive detections.

The distance between these two keypoints can be analyzed by the model to generate a raw pinch score, where a smaller distance corresponds to a higher pinch score. As depicted, certain natural or restful hand poses can cause the index fingertip keypoint 202 and thumb tip keypoint 204 to approach each other, which may be misinterpreted by the pinch model as an intentional pinch gesture. This is particularly common for a user's non-dominant hand while their focus is on an interaction being performed by the dominant hand. Such scenarios can lead to false-positive detections, necessitating the multistage filtering pipeline to validate the user's intent.

In the context of the present disclosure, a keypoint refers to a specific, identifiable anatomical landmark on a user's hand, such as a joint or fingertip, whose position is estimated by a computer vision model from video data. Each keypoint is represented by a set of data, which typically includes its three-dimensional spatial coordinates within the XR environment and a confidence score indicating the model's certainty in the accuracy of the estimated position. A collection of such keypoints, detected in a single frame of video, constitutes a skeletal representation of the hand, referred to as a hand pose. By analyzing the spatial relationships between these keypoints, both within a single frame (e.g., the distance between the thumb and index fingertips) and across a sequence of frames (e.g. their relative velocity), the system can interpret hand gestures and user intent. When both the user's hands are visible, the head-worn device may create keypoints for each hand and may track the keypoints to detect a pinch with either hand.

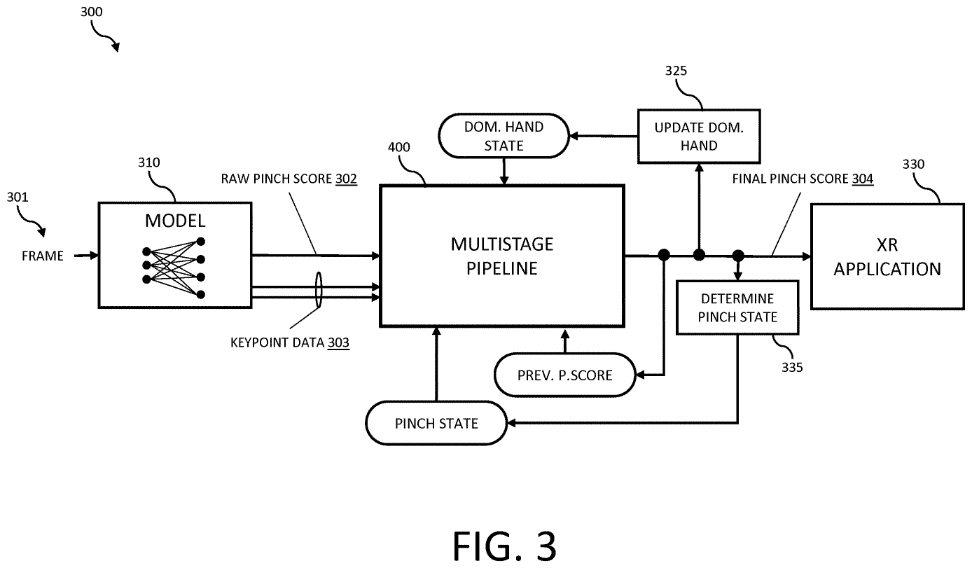

FIG. 3 is a system block diagram of a pinch detection system 300 (i.e., system) according to a possible implementation of the present disclosure. The system 300 processes inputs from a vision-based pinch model (i.e., model 310), which can include a raw pinch score 302 and associated keypoint data 303. This information is fed into a multistage filtering pipeline (i.e., multistage pipeline 400), which applies a sequence of heuristic filters to the raw pinch score 302 to validate the pinch gesture and mitigate false-positive detections. The multistage pipeline 400 is configured to determine a hand dominance state and selectively apply and/or adjust the filters based on which hand is performing the gesture. The final output of the multistage pipeline 400 is a refined pinch score (i.e., final pinch score 304) that more accurately reflects the user's intent, thereby improving the reliability of gesture-based interactions.

The input to the model 310 is a frame 301, which represents a single image of video data. In some implementations, the frame 301 is acquired by one or more cameras integrated into the head-worn device 110, which are configured to continuously capture images of the user's hands at a specific frame rate (e.g., 60 frames per second). Each frame 301 provides a two-dimensional representation of the user's hand pose at a discrete point in time. The model 310 processes this frame (i.e., image data) to perform hand tracking and gesture recognition, identifying anatomical landmarks to generate the keypoint data 303 and evaluating the spatial relationship between fingertips to compute the raw pinch score 302 for that specific frame. Each frame in a sequence may have a pinch score. Accordingly, a previous pinch score may refer to the pinch score for a frame earlier in the sequence of frames, such the frame immediately before the current frame.

The model 310 is a vision-based pinch model. As used herein, a “pinch model” refers to a computational model, which may be implemented as a machine learning model, configured to receive image data of a hand as input and output a raw pinch score and a set of keypoints representing the hand's pose. The model 310 analyzes the frame 301 of video data to perform initial hand tracking and gesture recognition. From this analysis, the model 310 generates the raw pinch score 302, which is an unfiltered value indicating the likelihood of a pinch gesture based on the proximity of the fingertips. The model further generates the keypoint data 303, which includes the spatial coordinates and confidence values for anatomical landmarks (i.e., keypoints) on the hand. The model 310 may be implemented in software or hardware within the head-worn device 110, and its outputs are subsequently fed into the multistage pipeline 400 for further processing and validation.

The multistage pipeline 400 is a processing framework that receives the outputs from the model 310 and applies a sequence of heuristic filters to validate the user's intent and mitigate false-positive detections. The pipeline processes several inputs to perform this validation. The primary inputs are the raw pinch score 302 and the keypoint data 303, both generated by the model 310. The raw pinch score 302 is an unfiltered, floating-point value indicating the initial likelihood of a pinch. The keypoint data 303 includes the spatial coordinates and confidence values for various points on the hand, which are used by the filters for kinematic analysis (e.g., closing velocity) and reliability checks. The pipeline also considers other data, such as the pinch score from a previous frame (i.e., prev. p. score) and a determined hand dominance state (i.e., dom. hand state), to dynamically adjust its filtering logic. The output of the multistage pipeline 400 is the final pinch score 304, which is the raw pinch score that has been increased or decreased to a value. The adjustment provided by the multistage pipeline 400 can help the head-worn device to adapt to the user's interactions without adding requirements for how these interactions are performed.

The final pinch score 304 is subsequently utilized by applications within the extended reality environment to control user interactions. As used herein, a “confirmed pinch” refers to a state that is registered when the final pinch score reaches a specific activation threshold, typically a value of 1.0. A primary use of the score is to trigger discrete events, where a score of 1.0 is interpreted as a confirmed pinch, analogous to a mouse click, for selecting user interface elements such as buttons or panels, or initiating a continuous action like grasping a three-dimensional object. Conversely, a score less than 1.0 indicates that a confirmed pinch has not occurred. Additionally, the floating-point value of the final pinch score 304 can be used to provide continuous visual feedback to the user, for example, by modulating the size or appearance of a cursor or selection reticle to indicate the proximity to a full pinch. The score may also serve as an input to other interaction models, such as an aim-activate system, which combines pinch data with hand-pointing information to enable more complex interactions. This multifaceted use of the final pinch score 304 allows for a flexible and intuitive interface that can be adapted to the specific needs of different applications.

The final pinch score 304 is also utilized by the multistage pipeline 400 in subsequent processing frames to maintain and update its internal state. The score from the current frame is used to determine 335 a pinch state, indicating whether a confirmed pinch (a score of 1.0) or a partial pinch (a score less than 1.0) is occurring. This pinch state, in turn, is used to update 325 the dominant hand state; for example, a confirmed pinch on the non-dominant hand may cause it to become the new dominant hand for subsequent interactions. Furthermore, the final pinch score 304 of the current frame is stored to serve as the previous pinch score in the next processing cycle, where it is used by various filters to differentiate between a new pinch and a held pinch, thereby enabling the pipeline to dynamically adjust its filtering criteria.

An exemplary extended reality application 330 (i.e., XR application) may utilize the final pinch score 304 to facilitate nuanced user interactions within a three-dimensional environment. For example, in a gaze-and-gesture interaction model, a user may direct their gaze toward an interactable surface, such as a user interface panel or a virtual object. As the user begins to form a pinch gesture, the application can leverage the continuous, floating-point value of the final pinch score to provide real-time visual feedback. This feedback could manifest as a selection reticle that dynamically changes in size or appearance, shrinking as the score approaches 1.0 to signal an imminent selection. Upon the final pinch score reaching 1.0, the application registers a confirmed pinch event. A brief pinch-and-release action may be interpreted as a discrete click for selecting a button, while a sustained pinch, where the score remains at 1.0, can initiate a continuous interaction, such as grasping and repositioning a three-dimensional object.

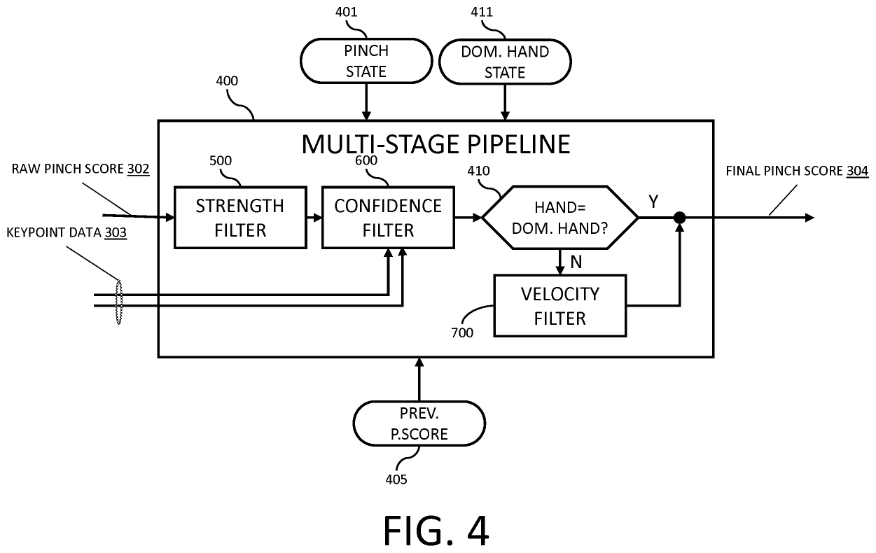

FIG. 4 is a block diagram illustrating the multistage filtering pipeline 400 for computing the final pinch score 304 according to a possible implementation of the present disclosure. The pipeline 400 receives the raw pinch score 302 and keypoint data 303 from the model 310, along with state information such as the previous pinch score 405 and the current dominant hand state 411. The raw pinch score 302 first passes through a strength filter 500, which can clamp the score to a maximum value based on the strength (i.e., amplitude) of the raw pinch score 302. The pinch score then proceeds to a confidence filter 600, which validates the gesture by assessing the confidence of the relevant keypoints. After the confidence filter 600, the pipeline's logic branches based on a decision 410 of whether the gesture is performed by the dominant or non-dominant hand. For the non-dominant hand, a velocity filter 700 is selectively applied, particularly for new pinch events, to prevent false positives from slow, unintentional hand movements. A new pinch is detected when the pinch score for the current frame indicates a confirmed pinch, while the score for the preceding frame did not. In other words, the pinch state 401 indicates that a detected pinch is new. The filters within the pipeline 400 are dynamically adjusted; for example, filter criteria may be stricter for a new pinch compared to a held pinch. By applying this sequence of heuristic checks, the pipeline 400 refines the raw pinch score to produce the final pinch score 304, which more accurately represents the user's intent.

The first stage of the pipeline 400 is the strength filter 500. The function of this filter is to process the raw pinch score 302 to resolve ambiguity in near-pinch states and improve the responsiveness of the interaction. The strength filter 500 compares the raw pinch score 302, which can be floating point value, against a pre-configured strength threshold. If the raw pinch score 302 exceeds this threshold, the filter clamps the score to a definitive value of 1.0, which signifies a confirmed pinch. If the score is below the threshold, it is passed on to the next filter without modification. This is particularly useful in scenarios where a user's fingertips are very close but not perfectly touching, which might cause the model 310 to output a high score (e.g., 0.98) that is not exactly 1.0. By clamping such high scores, the strength filter ensures that a clear user intention is immediately registered as a confirmed action, preventing situations where a user feels they have completed a pinch, but the system has not yet registered (i.e., confirmed) it.

The next stage in the pipeline is the confidence filter 600, which serves to validate the pinch gesture by assessing the reliability of the underlying keypoint data. This filter examines the confidence scores associated with the index fingertip keypoint 202 and the thumb tip keypoint 204. If the confidence of either keypoint drops below a dynamically adjusted confidence criterion, the filter discards the current pinch score and instead propagates the score from the last frame that had sufficient confidence. A false negative is an instance where the system fails to register a pinch gesture that the user intended to perform. This mechanism prevents such errors, which can arise from transient perception issues like motion blur or partial hand occlusion. The criterion is adaptive; it is stricter for a new pinch event to ensure high certainty for initial activations, and more permissive for a sustained (i.e., held) pinch to avoid unintentionally dropping a grabbed object during movement. Furthermore, the criterion is also stricter for gestures performed by the non-dominant hand to mitigate false positives from unintentional resting hand poses. For instance, a false positive may occur when a user rests their non-dominant hand on their lap while actively interacting with the XR environment using their dominant hand. In such a restful pose, the thumb and index finger of the non-dominant hand can naturally come into close proximity, which may cause the model 310 to generate a high raw pinch score. If this false positive were registered as a confirmed pinch, it could trigger an unintended action, such as locking a cursor or selecting an incorrect user interface (UI) element. By enforcing a stricter confidence criterion for the non-dominant hand, the confidence filter 600 can effectively reject these unintentional poses, as the keypoint data from a casually resting hand is less likely to meet the higher certainty requirements compared to the data from an actively and deliberately gesturing hand.

Following the confidence filter 600, the multistage pipeline 400 is configured to decide whether the gesture is being performed by the user's dominant hand or non-dominant hand. The decision 410 is based on the dominant hand state 411, which is a dynamic state that is updated based on user interactions. The system designates the hand that performed the most recent confirmed pinch gesture on an interactable surface as the dominant hand. Consequently, a confirmed pinch from the non-dominant hand can cause it to become the new dominant hand, allowing the user to seamlessly switch interaction hands. Upon initial system startup, the dominant hand state 411 is initialized to a pre-configured user preference (e.g., right-handed). The outcome of this decision 410 dictates the subsequent processing path: if the hand is dominant, the pinch score may be finalized, whereas if the hand is non-dominant, the score is passed to additional filters, such as the velocity filter 700, to further scrutinize the gesture for intentionality.

The velocity filter 700 is the final filtering stage for a pinch score resulting from a non-dominant hand. The velocity filter 700 is configured to mitigate false-positive detections arising from slow, unintentional hand movements. The velocity filter 700 is selectively enabled only when a new pinch is detected, meaning the pinch score for the current frame indicates a confirmed pinch while the score from the preceding frame did not. Upon activation, the velocity filter 700 performs an analysis of the movement (i.e., kinematic analysis) on the keypoint data 303. In particular, a closing velocity between the index fingertip keypoint 202 and the thumb tip keypoint 204 is computed. This closing velocity is then compared against a pre-configured velocity threshold. If the closing velocity is below this threshold, the filter concludes that the gesture lacks the deliberate speed of an intentional pinch and forces the pinch score to a low, non-activating value (e.g., 0.9). This prevents the registration of an unintended click but can still provide visual feedback in applications that render partial pinches. If the velocity meets or exceeds the threshold, the gesture is considered intentional, and the pinch score is passed on unmodified for finalization.

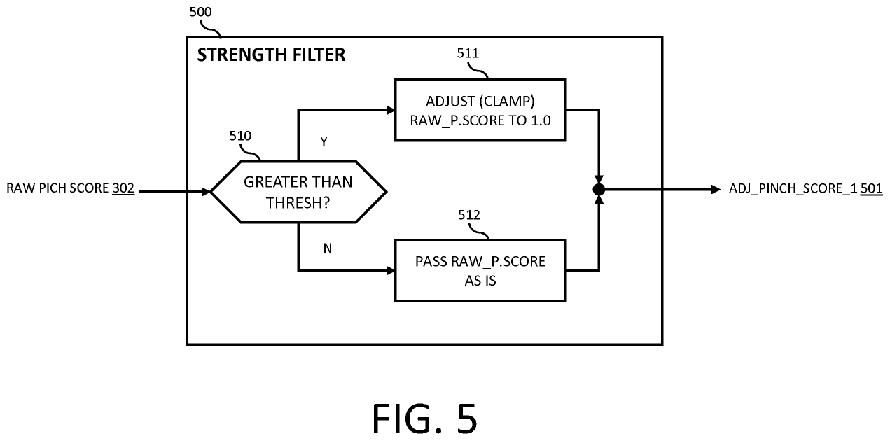

FIG. 5 is a block diagram illustrating the logic of the strength filter 500. As shown, the filter receives the raw pinch score 302 and compares this value against a pre-configured strength threshold 510. If the raw pinch score 302 exceeds the threshold, the filter clamps 511 raw pinch score 302 to a definitive value (e.g., 1.0) and passes the clamped score to the output. Otherwise, the raw pinch score 302 is passed 512 through unmodified to the output. The output of the strength filter 500 is the first adjusted pinch score 501 (i.e., adj_pinch_score_1).

The strength threshold 510 is a pre-configured, empirically determined value set to optimize the balance between interaction responsiveness and accuracy. In a non-limiting example, the threshold may be set to 0.95. This high value is chosen to resolve ambiguity for raw pinch scores that are very close to 1.0, which can occur when a user's fingertips are nearly, but not perfectly, touching. The selection of this value involves a trade-off: a lower threshold could increase the risk of false positives by clamping unintentional near-pinches, while a higher threshold could lead to false negatives if the model consistently outputs scores slightly below 1.0 for intentional pinches. Accordingly, the value is selected based on user testing and data analysis to ensure that gestures with a high likelihood of user intent are reliably registered as confirmed pinches.

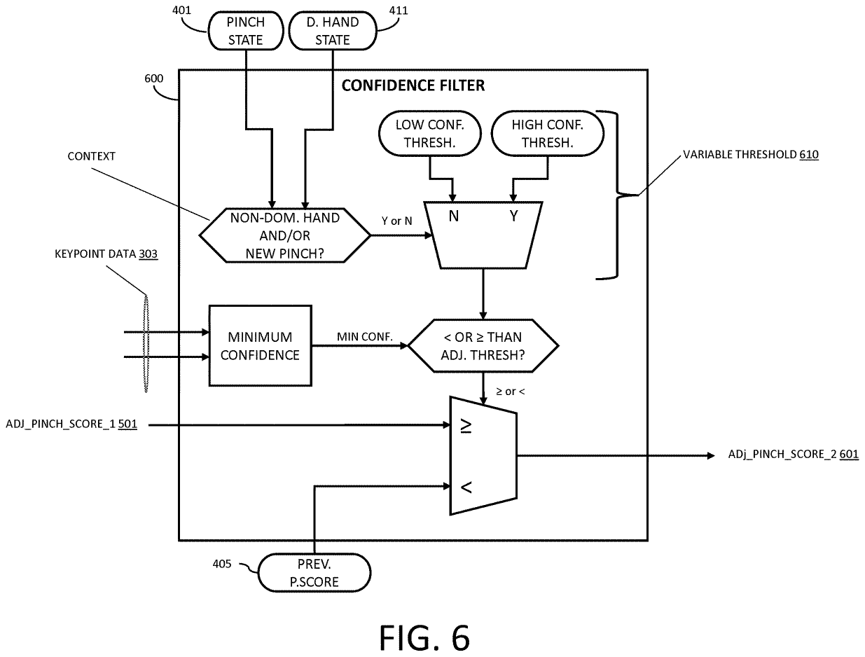

FIG. 6 is a block diagram illustrating the logic (i.e., rules) of the confidence filter 600. The confidence filter 600 receives the first adjusted pinch score 501 from the strength filter 500, along with confidence scores from the keypoint data 303. For example, two confidence scores from the keypoints in a pinch gesture, such as the index fingertip keypoint 202 and the thumb tip keypoint 204, may be analyzed to determine a minimum confidence. In this case, the minimum confidence (i.e., min. conf.) would be the smaller of the two confidence scores. The minimum confidence is then compared to a criterion (e.g., a confidence threshold). If the minimum confidence satisfies the criterion (e.g., ≥confidence threshold), then the confidence filter 600 is configured to pass the first adjusted pinch score 501 to the output. If the does not satisfy the criterion (e.g., <confidence threshold), then the confidence filter 600 is configured to discard the first adjusted pinch score 501 and instead propagate a previous pinch score 405. This is because the minimum confidence being below the threshold may indicate unreliable perception data due to factors like motion blur or occlusion, The output of the confidence filter 600 is a second adjusted pinch score 601 (i.e., adj_pinch_score_2).

The criterion is adaptive, becoming stricter for new pinch events and for gestures made by the non-dominant hand, while being more permissive for sustained pinches to avoid unintentionally dropping a held object. For example, the adaptive criterion can be a variable threshold 610 configured to use a relatively high confidence threshold (high conf. thresh.) to register a new pinch event, ensuring high certainty for initial activations. This higher threshold is also applied to any gesture from the non-dominant hand to prevent false positives from common resting hand poses. A lower, more permissive confidence threshold (low conf. thresh.) is used for a sustained pinch on the dominant hand to avoid unintentionally dropping a held object due to transient perception issues. As a non-limiting example, a new pinch on the non-dominant hand might require a minimum confidence of 0.7, whereas a held pinch on the dominant hand might only require a confidence of 0.4. This dynamic threshold adjustment helps to reject unintentional gestures while maintaining robust tracking for deliberate interactions.

A high confidence threshold, such as the 0.7 value for a new non-dominant pinch, is chosen to be conservative regarding ambiguous perception data. This relatively high value (as compared to the low threshold) favors clear and unambiguous perception data, which is typical of an intentional gesture. This higher threshold prevents accidental activations from a resting hand where fingers might be partially occluded, a situation that would likely result in lower confidence scores from the model.

A low confidence threshold, such as the 0.4 value for a held dominant pinch, prioritizes interaction continuity. This tolerance allows a user to maintain a grasp on a virtual object even if their hand moves quickly, which might cause motion blur and a temporary drop in keypoint confidence that would otherwise fall below the stricter threshold and cause a false negative (i.e., dropping the object). The specific values for these thresholds are typically determined empirically through extensive user testing and data analysis, seeking to optimize the balance between minimizing false positives and preventing false negatives across a diverse range of users, hand poses, and environmental conditions.

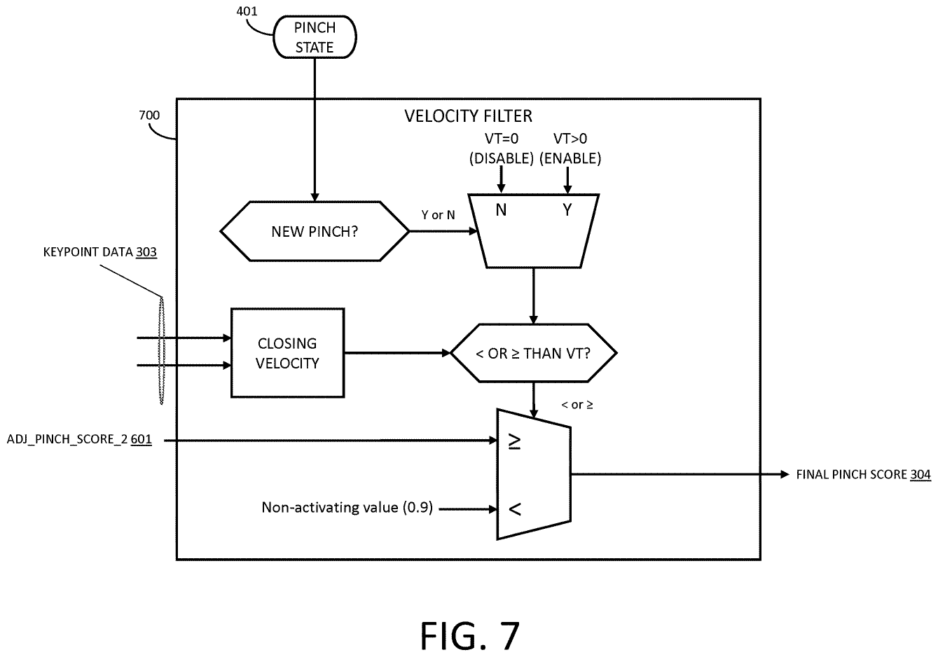

FIG. 7 is a block diagram illustrating the logic of the velocity filter 700. This filter is selectively applied only to gestures from the non-dominant hand and is enabled only when a new pinch is detected (i.e., the current pinch score indicates a confirmed pinch, but the previous pinch score 405 did not). The velocity filter 700 receives the second adjusted pinch score 601 from the confidence filter 600 and the keypoint data 303. It uses the keypoint data 303 to compute a closing velocity between the index and thumb fingertips, which is then compared against a pre-configured velocity threshold (VT). If the closing velocity is below this threshold, the gesture is deemed to lack the deliberate motion of an intentional pinch, and the filter forces the pinch score to a low, non-activating value (e.g., 0.9). This prevents a false-positive detection while still allowing applications to provide visual feedback of a near-pinch state. If the closing velocity meets or exceeds the threshold, the gesture is considered intentional, and the second adjusted pinch score 601 is passed through unmodified as the final pinch score 304.

The velocity threshold (VT) is a configurable parameter that dictates the minimum required speed for a pinch gesture to be validated as intentional, thereby providing a mechanism to enable or disable the velocity check. Setting the velocity threshold (VT) to a value greater than zero enables the filter, establishing a baseline speed that helps differentiate a deliberate pinching motion from a slow, incidental closure of the fingertips. Conversely, the filter can be effectively disabled by setting the velocity threshold (VT) to zero. In this configuration, since a calculated closing velocity cannot be negative, the velocity will always meet or exceed the zero-value threshold, causing the pinch score to pass through the filter unmodified regardless of speed.

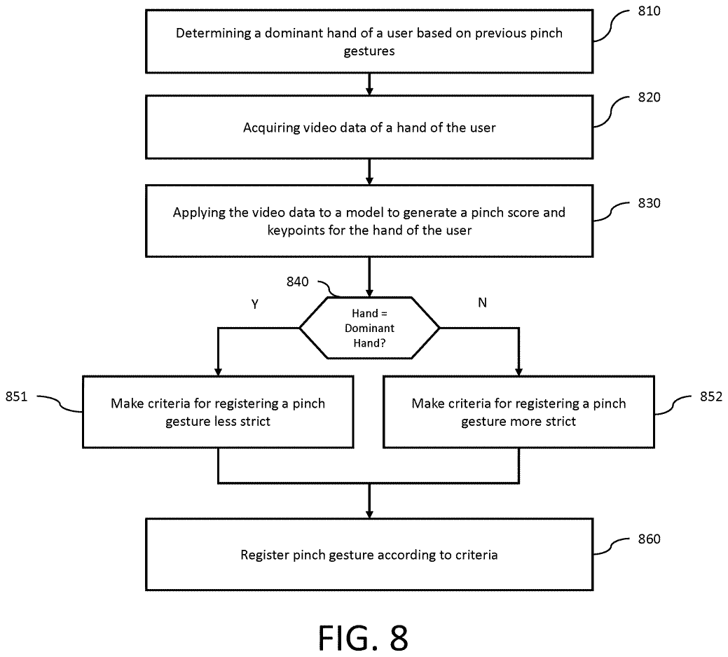

FIG. 8 is a flowchart of a method for registering a pinch gesture, summarizing the overall process from acquiring video data of a hand to generating a final pinch score via the multi-stage filtering pipeline. The method begins at block 810 by determining the dominant hand of the user. Next, at block 820, video data of a hand of the user is acquired by one or more cameras integrated into a head-worn device. At block 830, the video data is processed by a vision-based model, which may be implemented as a machine learning model, to analyze the hand and generate a raw pinch score and corresponding keypoint data. At block 840, the hand (from block 820) is compared to the dominant hand (from block 810) to determine if the hand forming the pinch gesture is the dominant hand. If the hand is the dominant hand (i.e. Y), then the criteria used by the multistage pipeline to register a pinch data is made less strict at block 851. If the hand is not the dominant hand (i.e., NO), then the criteria used by the multistage pipeline to register the pinch data is made more strict at block 852. At block 860, the pinch gesture is registered by the multistage pipeline according to the criteria.

The multistage pipeline is configured to generate a final pinch score to validate or invalidate a pinch gesture. The pipeline includes a confidence filter configured to determine a confidence corresponding to the keypoints and pass the pinch score for further processing when the confidence satisfies a criterion, which is stricter for a non-dominant hand and when a new pinch is detected. The pipeline also includes a velocity filter configured to determine a closing velocity corresponding to the keypoints and force the pinch score to a low value when the closing velocity is below a velocity threshold; this filter is only applied to the non-dominant hand and is enabled only when the new pinch is detected.

The final pinch score may be output to an application to control an interaction with an interactable surface, such as a user interface panel, a button, or a three-dimensional object. A final pinch score equal to 1.0 indicates a pinch gesture, and a score less than 1.0 does not. The dominant hand may be updated to be the non-dominant hand when the final pinch score for the non-dominant hand is equal to 1.0. A new pinch is detected when a current pinch score indicates a confirmed pinch and a pinch score from a preceding frame of the video data does not. The criterion of the confidence filter may be a first criterion for the new pinch and a second, more permissive criterion for a held pinch. The multi-stage filtering pipeline may also include a strength filter configured to clamp the pinch score to a maximum value when the pinch score exceeds a strength threshold. Upon initial startup, the dominant hand may be set to a pre-configured preference of the user. The dominant hand may also be reset to the pre-configured preference if a predetermined period of time has passed since the last validated pinch gesture was performed by the hand that is not the pre-configured preference. The low value forced by the velocity filter may be 0.9, corresponding to a near pinch gesture. When the confidence does not satisfy the criterion, the confidence filter may be further configured to output a pinch score from a previous frame of the video data that had a confidence that satisfied the criterion.

The application of stricter criteria is principle of the multistage filtering pipeline, designed to differentiate between intentional user gestures and unintentional hand poses that could otherwise lead to false-positive detections. “Stricter criteria” refers to the use of more demanding thresholds and the selective application of additional validation filters. For example, the confidence threshold for registering a new pinch is set higher than the threshold for maintaining a held pinch. This ensures a high degree of certainty before initiating an action, while being more forgiving during continuous interactions to prevent false negatives, such as unintentionally dropping a grabbed object due to motion blur. Furthermore, the criteria are significantly stricter for the non-dominant hand. This is because users often rest their non-dominant hand in poses where the fingertips are naturally close, a common source of false positives. To counter this, a gesture from the non-dominant hand must not only meet a higher confidence threshold but is also subjected to the velocity filter, which verifies that the closing motion of the fingertips is sufficiently fast to be considered deliberate. In contrast, the dominant hand, which is actively used for interaction, is subject to more permissive criteria to ensure a fluid and responsive user experience.

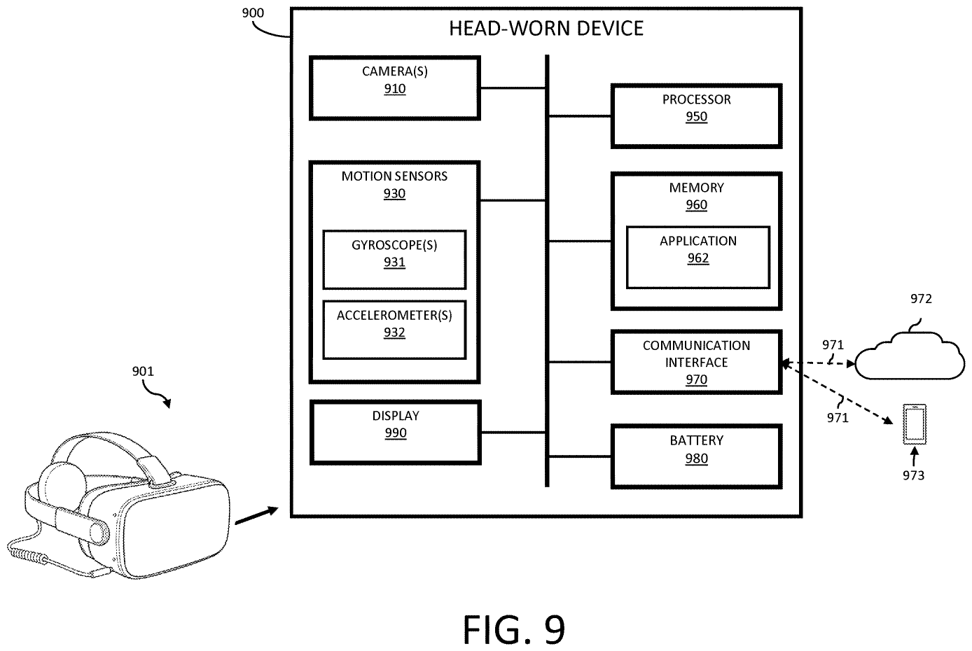

FIG. 9 illustrates a head-worn device according to a possible implementation of the present disclosure. The head-worn device 900, which can be implemented as a VR headset 901, contains the hardware necessary to perform the gesture detection methods described herein. The device 900 includes a processor 950 that executes instructions stored in memory 960. These instructions may be part of an application 962 that implements the multi-stage filtering pipeline. One or more cameras 910 capture video data of the user's hands, which serves as the input to the pinch detection model processed by the processor 950. The head-worn device 900 also includes motion sensors 930, such as gyroscopes 931 and accelerometers 932, for tracking the device's movement and orientation. A display 990 presents the virtual or augmented reality environment to the user, and interactions within this environment are controlled by the final pinch scores generated by the system. A communication interface 970 allows for data transfer to a network 972 (e.g., cloud) or a mobile computing device 973 via a communication link 971. The head-worn device includes a battery 980 configured to provide power to the device for operation. In operation, the processor 950 utilizes the various components to acquire hand data via the cameras 910, process it through the filtering pipeline stored in memory 960, and render the resulting interactions on the display 990. The memory 960 can be a non-transitory computer-readable medium storing instructions, such as application 962, that when executed by processor 950, cause the device to perform the pinch gesture detection method, including the application of the multi-stage filtering pipeline.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
acquiring video data of a user,
applying frames of the video data to a model to generate a raw score and keypoints for each frame that includes a hand of the user; and
applying the raw score and the keypoints to a pipeline to generate a final score, the pipeline including:
a first filter configured to determine a confidence corresponding to the keypoints and pass the raw score as an intermediate score when the confidence satisfies a criterion, wherein the criterion includes a variable threshold configurable to a first value for the hand being a non-dominant hand of the user and configurable to a second value for the hand being a dominant hand of the user, the first value being greater than the second value; and
a second filter configured to receive the intermediate score from the first filter when the hand is the non-dominant hand, the second filter further configured to determine a closing velocity corresponding to the keypoints and reduce the intermediate score to generate the final score when the closing velocity is below a velocity threshold.

2. The method according to claim 1, further comprising:
outputting the final score to an application to control an interaction with an interactable surface in an extended reality environment.

3. The method according to claim 2, wherein the interactable surface comprises at least one of a user interface panel, a button, or a three-dimensional object.

4. The method according to claim 1, further comprising:
registering the final score as a pinch gesture when the final score is equal to a predetermined value; and
not registering the final score as the pinch gesture when the final score is less than the predetermined value.

5. The method according to claim 4, further comprising:
changing the dominant hand for the pipeline when the pinch gesture is registered for the non-dominant hand.

6. The method according to claim 1, further comprising:
identifying a pinch detected for a fame as a new pinch when no pinch is detected in a preceding frame of the video data; and
identifying the pinch detected for the frame as a held pinch when the pinch is also detected in the preceding frame of the video data.

7. The method according to claim 6, further comprising:
configuring the variable threshold to the first value for the new pinch; and
configurating the variable threshold to the second value for the held pinch.

8. The method according to claim 1, wherein the pipeline further includes a third filter configured to clamp the raw score to a predetermined value corresponding to a registered pinch gesture when the raw score exceeds a strength threshold.

9. The method according to claim 1, further comprising:
setting the dominant hand for the pipeline to a stored preference upon an initial start of a device.

10. The method according to claim 9, further comprising:
changing the dominant hand for the pipeline to the hand opposite the stored preference when a pinch gesture is registered for the non-dominant hand; and
resetting the dominant hand to the stored preference after a period of time without registering another pinch gesture for the non-dominant hand.

11. The method according to claim 1, wherein:
the raw score has a value in a range from a minimum value to a maximum value based on a distance between a first keypoint corresponding to an index fingertip and a second keypoint corresponding to a thumb tip.

12. The method according to claim 1, wherein the first filter is further configured to:
output a final score from a previous frame of the video data when the confidence for a frame does not satisfy the criterion.

13. A head-worn device, comprising:
a camera configured to acquire video data of a user;
a processor; and
a memory storing instructions, that when executed by the processor, cause the head-worn device to:
apply frames of the video data to a model to generate a raw score and keypoints for each frame that includes a hand of the user; and
apply the raw score and the keypoints to a pipeline to generate a final score, the pipeline including:
a first filter configured to determine a confidence corresponding to the keypoints and pass the raw score as an intermediate score when the confidence satisfies a criterion, wherein the criterion includes a variable threshold configurable to a first value for the hand being a non-dominant hand of the user and configurable to a second value for the hand being a dominant hand of the user, the first value being greater than the second value; and
a second filter configured to receive the intermediate score from the first filter when the hand is the non-dominant hand, the second filter further configured to determine a closing velocity corresponding to the keypoints and reduce the intermediate score to generate the final score when the closing velocity is below a velocity threshold.

14. The head-worn device according to claim 13, wherein the instructions, when executed by the processor, further cause the head-worn device to:
output the final score to an application configured to register the final score as a pinch gesture based on the final score; and
control an interactable surface of an extended reality environment based on the pinch gesture.

15. The head-worn device according to claim 14, wherein the instructions, when executed by the processor, further cause the head-worn device to:
change the dominant hand for the pipeline when the pinch gesture is registered for the non-dominant hand.

16. The head-worn device according to claim 13, wherein the instructions, when executed by the processor, further cause the head-worn device to:
identify a pinch detected for a frame as a new pinch when no pinch is detected in a preceding frame of the video data; and
identifying the pinch detected for the frame as a held pinch when the pinch is also detected in the preceding frame of the video data.

17. The head-worn device according to claim 16, wherein the instructions, when executed by the processor, further cause the head-worn device to:
configure the variable threshold to the first value for the new pinch; and
configure the variable threshold to the second value for the held pinch.

18. The head-worn device according to claim 13, wherein the pipeline further includes a third filter configured to clamp the raw score to a predetermined value corresponding to a registered pinch gesture when the raw score exceeds a strength threshold.

19. The head-worn device according to claim 13, wherein the confidence filter is further configured to:
output a final score from a previous frame of the video data when the confidence for a frame does not satisfy the criterion.

20. A non-transitory computer-readable medium storing instructions that, when executed by a processor, cause the processor to:
acquire video data of a user;
apply frame of the video data to a model to generate a raw score and keypoints for each frame that includes a hand of the user; and
apply the raw score and the keypoints to a pipeline to generate a final score, the pipeline including:
a first filter configured to determine a confidence corresponding to the keypoints and pass the raw score as an intermediate score when the confidence satisfies a criterion, wherein the criterion includes a variable threshold configurable to a first value for the hand being a non-dominant hand of the user and configurable to a second value for the hand being a dominant hand of the user, the first value being greater that the second value; and
a second filter configured to receive the intermediate score from the first filter when the hand is the non-dominant hand, the second filter further configured to determine a closing velocity corresponding to the keypoints and reduce the intermediate score to generate the final score when the closing velocity is below a velocity threshold.
